(19) United States
(12) Patent Application Publication
(10) Pub. No.: US 2013/0235335 A1
(43) Pub. Date: Sep. 12, 2013

(54) METHOD FOR ALTERING THE OPTICAL DENSITY AND SPECTRAL TRANSMISSION OR REFLECTANCE OF CONTACT LENSES

(71) Applicants: James Arthur Forrest, Burgessville (CA); Lyndon William James Jones, Waterloo (CA); Bradley Jordan Hall, Sarnia (CA)

(72) Inventors: James Arthur Forrest, Burgessville (CA); Lyndon William James Jones, Waterloo (CA); Bradley Jordan Hall, Sarnia (CA)

(21) Appl. No.: 13/883,036

(22) PCT Filed: Nov. 3, 2011
(86) PCT No.: PCT/CA2011/050686

§ 371 Date: May 2, 2013

Related U.S. Application Data
(60) Provisional application No. 61/409,752, filed on Nov. 3, 2010.

(51) Int. Cl. G02C 7/04

(52) U.S. Cl. CPC G02C 7/04
USPC 351/159.33; 351/159.73; 351/159.02

(57) ABSTRACT

A contact lens having nanoparticles integrated within, or deposited onto, the contact lens. A method for altering the optical density and spectral transmission or reflection response of a contact lens. The method includes obtaining a nanoparticle solution having a predetermined concentration. The method further includes exposing the contact lens in the nanoparticle solution for a predetermined period of time. A method for manufacturing a contact lens further includes exposing contact lens material to nanoparticles for a predetermined period of time to alter the optical density and spectral transmission or reflection response of the contact lens material. A contact lens may be formed after the material is exposed to the nanoparticles.

### CROSS-REFERENCE TO RELATED APPLICATIONS

This application claims the benefit of priority of U.S. Provisional Patent Application No. 61/409,752 filed Nov. 3, 2010, which is incorporated herein by reference in its entirety.

### FIELD

The present disclosure relates generally to contact lenses. More particularly, the present disclosure relates to a method for altering the optical density and spectral transmission or reflectance of contact lenses and contact lenses with altered optical density and spectral transmission or reflectance.

### BACKGROUND

Cosmetic (or tinted) contact lenses are an important segment of the contact lens market. Contact lenses are tinted for a variety of reasons: to enhance visibility of the lens (to improve lens handling); cosmetic vanity (to change the appearance of the eye from one colour to another); to improve the appearance of eyes damaged through, for example, trauma and restore the eyes to a more natural appearance; to reduce the amount of ultraviolet (UV) light that hits the retina (to protect the eye from UV damage); or to reduce the amount of visible light that hits the retina in patients sensitive to light. For this final reason, visual function is improved in patients suffering from diseases such as achromatopsia, which is a congenital disorder where cone function is severely reduced or nonexistent.

Tinted contact lenses are manufactured to produce either translucent tints (including, for example, dye dispersion tinting, vat dye tinting, chemical bond tinting, and printing techniques), or opaque tints (typically incorporating dot matrix printing, laminate constructions, and opaque backing techniques). Dye dispersion tinting is used to tint rigid lenses only, as the dye is water soluble and would leach out from soft lenses. In this process, the dye is mixed in with the lens material prior to polymerization, resulting in an even distribution of dye in the lens. A few problems with this method are that the pupil area of the lens cannot be clear and the density of the tint depends on the lens thickness.

Vat dye tinting involves soaking lenses in water-soluble dye at a specific temperature for a specific amount of time, followed by exposure to air, which changes the solubility of the dye and locks the dye in the lens material. This technique produces a uniform tint that is independent of lens thickness.

Chemical bond tinting involves soaking lenses in dye solution, in the presence of a catalyst, which creates a strong covalent bond between the dye and the lens material. After soaking, the lenses go through several extraction processes to remove any unreacted dye. This process also creates a uniform tint on lenses.

The printing technique for tinting lenses is similar to the technique of printing ink onto paper. This technique can produce tints using different colours and can maintain a clear area over the pupil. Dot matrix printing involves chemically bonding opaque dots of dye to the lens surface. The appearance of the lens will involve both the look of the opaque dots and the reflections off the iris seen between the dots. Laminate constructions paint a pattern on hydroxyethyl methacrylate (HEMA), which is then covered with more HEMA. This technique locks the dye between the HEMA layers, but also decreases oxygen transmission through the lens due to high lens thickness. Opaque backing involves tinting the inner lens material with a translucent dye and tinting the back portion of the lens with an opaque dye.

Although tinted contact lenses have numerous benefits, they are not without problems, due to the fact that in many countries these lenses are not legislated in the same way that prescription contact lenses are, allowing them to be sold as “over-the-counter” items, without appropriate oversight from a qualified practitioner. Over-the-counter sale of lenses to consumers without a prescription or instructions on proper lens care, has led to serious ocular complications. In addition, current tinted contact lenses are traditional HEMA-type lenses with corresponding low oxygen permeability, resulting in potential hypoxia of the cornea.

It is, therefore, desirable to provide a novel method for alternating the optical density and spectral transmission of contact lenses, particularly silicone hydrogel lenses, which transmit substantially higher amounts of oxygen than lenses based on (poly)HEMA.

### SUMMARY

There is provided a method for altering the optical properties of a contact lens, particularly silicone hydrogel lenses.

In a first aspect, the present disclosure provides a method for altering the optical density and spectral transmission or reflection response of a contact lens including: obtaining a nanoparticle solution having a predetermined concentration; and exposing the contact lens in the nanoparticle solution for a predetermined period of time.

In some cases, there is provided a solution made of gold, silver or a mixture of gold and silver nanoparticles. In other cases, each nanoparticle may be a combination of gold and silver.

In another aspect, there is provided a contact lens wherein nanoparticles are incorporated into the contact lens.

In yet another aspect there is provided a method for manufacturing a contact lens including exposing contact lens material to nanoparticles for a predetermined period of time to altering the optical density and spectral transmission or reflection response of the contact lens material.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 illustrates a method for adjusting the optical properties of a contact lens;

FIG. 2 is a graph showing light transmission through a senofilcon A lens soaked in gold nanoparticles for 3 hours;

FIG. 3 is a graph showing light transmission through a senofilcon A lens soaked in gold nanoparticles for 20 hours;

FIG. 4 is a graph showing light transmission through an alphafilcon A lens soaked in gold nanoparticles for 3 hours;

FIG. 5 is a graph showing light transmission through an alphafilcon A lens soaked in gold nanoparticles for 20 hours;

FIG. 6 shows an optically clear, non-tinted contact lens;

FIG. 7 illustrates a senofilcon A lens tinted with gold nanoparticles;

FIG. 8 illustrates a comfilcon A lens tinted with gold nanoparticles;

FIG. 9 illustrates a lotrafilcon B lens tinted with gold nanoparticles;

FIG. 10 illustrates a balafilcon A lens tinted with gold nanoparticles;

FIG. 11 illustrates a senofilcon A lens tinted with silver nanoparticles;

FIG. 12 illustrates a comfilcon A lens tinted with silver nanoparticles;

FIG. 13 illustrates a lotrafilcon B lens tinted with silver nanoparticles

FIG. 14 illustrates a balafilcon A lens tinted with silver nanoparticles

FIG. 15 illustrates two senofilcon A lenses tinted with different ratios of gold nanoparticles to silver nanoparticles;

FIG. 16 illustrates two senofilcon A lenses tinted with different ratios of gold nanoparticles to silver nanoparticles;

FIG. 17 illustrates senofilcon A lenses tinted for various amounts of time in two different concentrations of gold nanoparticles;

FIG. 18 is a scanning electron microscope image of a nanoparticle coated lens;

FIG. 19 is an atomic force microscope image of an optically clear, non-coated lens;

FIGS. 20A and 20B are atomic force microscope images of a nanoparticle coated contact lens;

FIG. 21 illustrates a water bubble on an optically clear, non-tinted lens;

FIG. 22 illustrates a water bubble on a lens exposed to a gold nanoparticle solution;

FIG. 23 is a graph illustrating leaching data two months after exposure had occurred; and

FIG. 24 is a graph illustrating toxicology results.

### DETAILED DESCRIPTION

Generally, the present disclosure provides a method for altering the optical properties, including the optical density and spectral transmission or reflectance, of a contact lens. The optical density may be changed with or without changing the colour or tint of the contact lens. First, a nanoparticle-based solution is prepared. The nanoparticle-based solution is intended to alter the optical properties including the optical density and spectral transmission or reflectance. The solution may be prepared using gold (Au) nanoparticles, silver (Ag) nanoparticles, a combination of gold and silver nanoparticles, nanoparticles made from a combination of gold and silver (each nanoparticle contains gold and silver), or other nanoparticles, as described below. The process for producing a nanoparticle solution is disclosed, however a pre-manufactured solution may also be used.

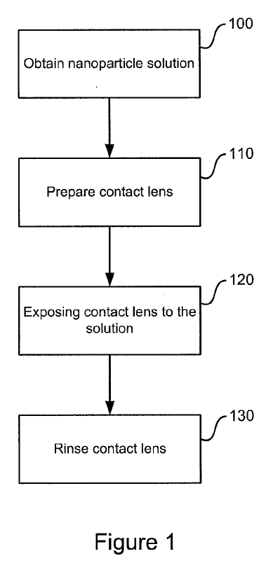

FIG. 1 is a first method of altering the optical characteristics of a contact lens. In order to adjust the optical density of the contact lens, a nanoparticle solution is obtained (100). The solution may be manufactured or purchased. If manufactured, the solution may comprise a gold chloride hydrate or a silver nitrate that is mixed in a heat proof container with deionized water. Other metals or metal alloys, such as platinum, may be used in a similar fashion. A citric acid solution may be added and the mixture boiled until a colour change is noted. The resulting nanoparticle solution can then be cooled for use in the method to alter the optical properties of the contact lens. Other methods of obtaining a metallic nanoparticle solution may be known, including purchasing a previously made nanoparticle solution or using another method to fabricate the solution. The concentration of the nanoparticle solution should be in a range where once the nanoparticles have been deposited on the contact lens material, the contact lens material appears to be optically changed, but, in most instances, still allows a user to clearly see through the lens. It will be understood that, in most cases, with a lower concentration or a shorter the exposure time, or both, the lighter the resulting optical impact on the contact lens.

The contact lens is then prepared (110) for exposure to the nanoparticle solution. In some cases, the contact lens is rinsed of its storage liquid so that the ions in the solution do not cause aggregation of the nanoparticles. Although not necessary in all embodiments, the contact lens may then be dried. In other cases, the contact lens material may be prepared for exposure to the nanoparticle solution prior to being formed into contact lenses. In still other cases, the contact lenses may be exposed to the nanoparticle solution post manufacture but prior to sale to an end user.

The contact lens, or contact lens material, is then exposed to or submerged in (120) the metallic nanoparticle solution. The time to alter the optical properties will depend upon the desired effect, and may take between a few seconds to several hours, depending on the preferred results. In a particular case, the contact lens material may be exposed to the nanoparticle solution between 6 and 10 hours. In another case, the contact lens material may be exposed to the nanoparticle solution for longer than 10 hours. Once certain optical changes are obtained, the contact lens is removed from the nanoparticle solution and rinsed (130). The contact lens material will now exhibit different optical properties than prior to exposure, and may appear a different colour. These changes may be irreversible. In other embodiments, the changes may lasts for several days, weeks or months.

The size, shape and other properties of the nanoparticles within the nanoparticle solution change the optical effects obtained. For metal nanospheres, a diameter of approximately 60 nanometers (nm) or smaller is preferred, as otherwise the particles may sediment.

In one particular example of metallic nanoparticle solution preparation, a gold nanoparticle preparation may be prepared using approximately 0.034 grams (g) of gold chloride hydrate dissolved in about 100 milliliters (mL) of deionized water to prepare a solution of 1 millimolar (mM) gold chloride. The ratio may be changed to produce a stronger or weaker concentrated solution. The measurements are by way of example only, and more or less of the solution can be prepared depending on the desired amount and concentration of nanoparticle solution.

The solution is then heated to a boiling point and a magnetic stir bar may be added to keep the solution homogenous. Once boiling, a 1% by weight citric acid solution may be added. In one example, for the 100 mL solution described above, 10 mL of the citric acid solution is added. The ratio of citric acid solution to gold chloride solution should remain at approximately 10%, however, a larger quantity of citric acid solution may be added for larger quantities of gold chloride solution.

After the addition of the citric acid solution, the resulting solution mixture is left boiling until a deep red colour change is observed. In the above example, this change may be observed in about 7 minutes after the citric acid solution is added. The solution mixture is then removed from the heat source and left to cool, preferably, to room temperature. The resulting nanoparticle solution may then be used to alter the optical density of contact lenses, for example by tinting the contact lenses.

In the above example, the optical density of this solution as prepared is about 2.36 at 523 nm. The optical density is a number whereby the value of 1 would mean that only 10% of the light is transmitted. This result corresponds to a nanoparticle concentration of about 1.5×10̂(12)/mL and diameter of 20 nm. Various concentrations of gold chloride hydrate will result in a nanoparticle solution with higher or lower optical density and size and shape of nanoparticles. Methods to modify the size and shape of the nanoparticle within the solution will be understood by a person skilled in the art.

In another specific example, a silver nanoparticle solution may be prepared for use as the optical properties altering solution. For this solution, approximately 0.02125 grams of silver nitrate is dissolved in about 125 mL of de-ionized water to prepare a solution of 1 mM silver nitrate. The solution is then heated to a boil. Once boiling, 5 mL of a 1% by weight citric acid solution is added. The solution mixture is left on the heat at a boil until a pale yellow colour change is observed in the solution mixture. In the above example, the change took place in about 7 minutes. The solution mixture is then removed from the heat source and left to cool to room temperature. The final solution contains a nanoparticle concentration of approximately 1.1−2.6×10⁽⁹⁾/mL and diameter is 60-80 nm. By varying the parameters, the final nanoparticle solution may contain a different concentration or nanoparticles of larger or smaller diameters.

It will be understood that the concentration may vary in order to modify the colour or optical properties of the nanoparticle solution and the optical properties required for the altered contact lens material.

In an example embodiment, once the nanoparticle solution is obtained, the contact lens is then prepared. The preparation of the contact lens may include removing the lens from a blister pack or other packaging, rinsing the lens in deionized water, and drying the lens on lens paper. While discussed in the singular, it is likely that pairs of contact lenses would be prepared at the same time. A rinsed and dry contact lens is preferred in order to not dilute the nanoparticle solution once the contact lens is added. The contact lens is then inserted into or otherwise exposed to the nanoparticle solution. Lenses of hydrogel materials, for example alphafilcon A (a conventional hydrogel), senofilcon A, lotrafilcon B, comfilcon A, or balafilcon A (silicone hydrogel materials), may have their optical properties altered. Examples of different lenses which have been optically altered are provided in the figures. Altering the optical density may include tinting the contact lenses, although the optical density can be altered without changing the colour. It will be understood that the process as described in this example embodiment may be completed at any time post-fabrication of the contact lens. Either the end-user of the contact lens may choose to alter the optical density or the contact lens manufacturer may wish to apply this method prior to distributing or selling contact lenses.

Once the nanoparticle solution and the contact lens have been prepared, the contact lens may be optically altered or adjusted. The contact lens may be placed into a storage container that allows the contact lens to be covered by or completely submerged into the nanoparticle solution. The contact lens is soaked for a designated amount of time depending on the desired properties for the lens. In one case, the lens may be submerged and soaked in the nanoparticle lens solution for several seconds to several minutes. In another case, the lens may be soaked for approximately 6 to 10 hours. In yet another case, the lens is exposed to the nanoparticle solution for over 10 hours.

In another example embodiment, the contact lens material may be exposed to nanoparticles or the nanoparticle solution to directly incorporate the nanoparticles into the contact lens material. The contact lens material may then be formed into at least one contact lens and the nanoparticles may be integrated within, or directly incorporated, with the at least one contact lens by being incorporated into the contact lens material. The contact lens may then be packaged and sold to the end user after the optical properties of the original lens material have been altered. A similar process may also occur after the contact lens has been formed or post manufacture but prior to sale to an end user.

By directly incorporating the nanoparticles into the contact lens material the optical properties of the original lens material may be altered. This process is intended to have a number of benefits including:
i. Making the contact lens a specific colour or hue to enhance or change the appearance or colour of the end user's eye. This may be valuable for cosmetic situations in which the end user wishes to change the perceived eye colour, or have corneal disease in which the lens would provide a cosmetic improvement to the diseased state.
ii. Controlling the amount of light that hits the retina, to improve ocular comfort in bright light for individuals who are light sensitive or have retinal or ocular disease that makes a person unable to function optimally in bright light situations.

In the examples shown in the figures below, lenses were exposed to different nanoparticle solutions such as gold nanoparticle solution, silver nanoparticle solution, and mixtures of gold and silver nanoparticle solution. After exposure to the nanoparticle solution, the lenses were removed and rinsed in deionized water. Rinsing of the lens may be performed to remove any non-absorbed nanoparticle solution. In other embodiments the lenses could be exposed to nanoparticles made from a combination of gold and silver. In the experimental phase, the lenses were subsequently stored in phosphate buffered saline for up to 6 months, without losing the optical properties now imparted to the contact lenses.

Experimentation was conducted on the above methods to review the absorption data of the various hydrogel contact lenses with the nanoparticle solutions. Data on the modification of optical properties is of two types. In the first set of figures, a quantitative measure of the percent transmission was required. Optical transmission spectra were taken using a spectrometer. In the second set, a digital camera was used to acquire images of the tinted contact lens in buffer solution.

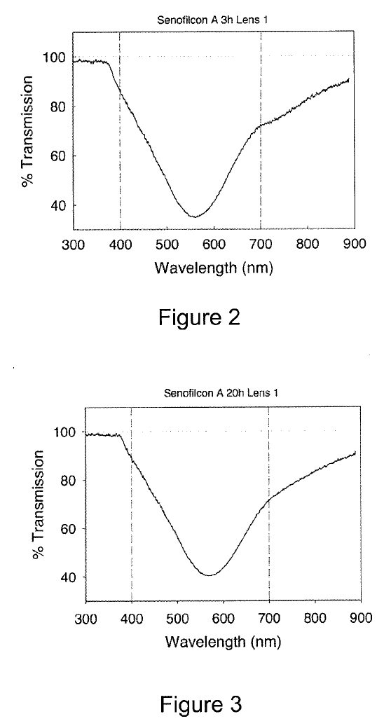

FIG. 2 shows the percentage of light transmission through a senofilcon A lens that had soaked in gold nanoparticle solution for approximately 3 hours, while FIG. 3 shows the light transmission after it had been soaked for about 20 hours. The space between the dashed lines represents the approximate range of the visual spectrum of light.

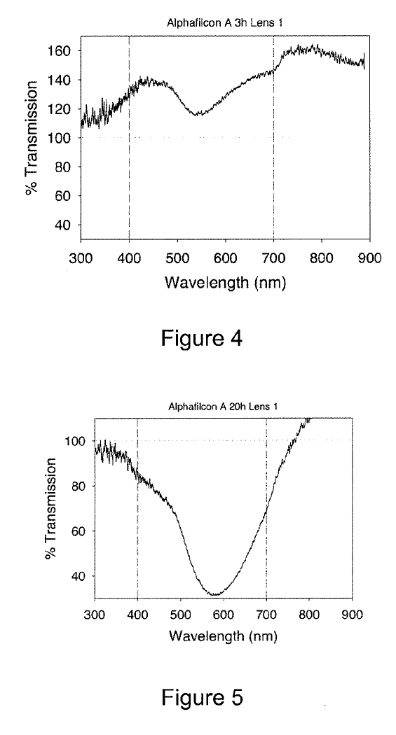

FIGS. 4 and 5 show the light transmission through an alphafilcon A lenses soaked in gold nanoparticles for approximately 3 and 20 hours respectively. The space between the dashed lines represents the approximate range of the visual spectrum of light.

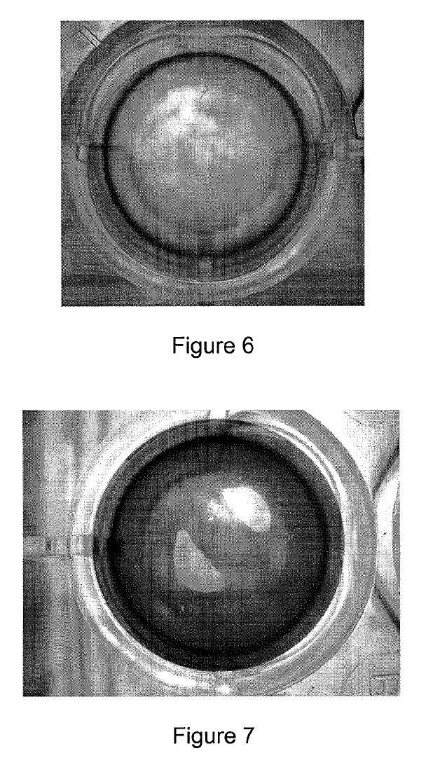

FIG. 6 illustrates a non-dyed lens in a buffer solution. The various types of hydrogel contact lenses look very similar when submerged within a buffer solution

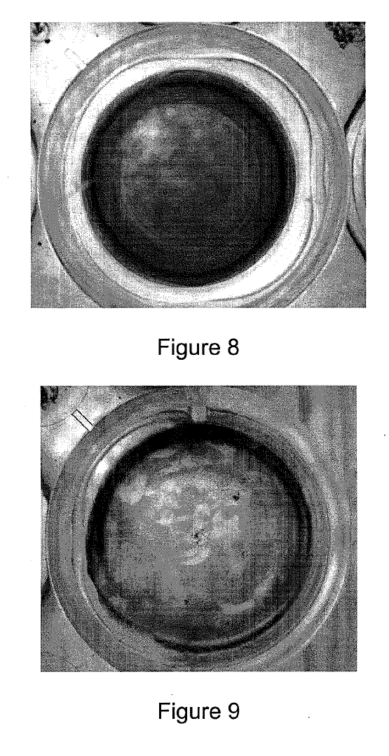

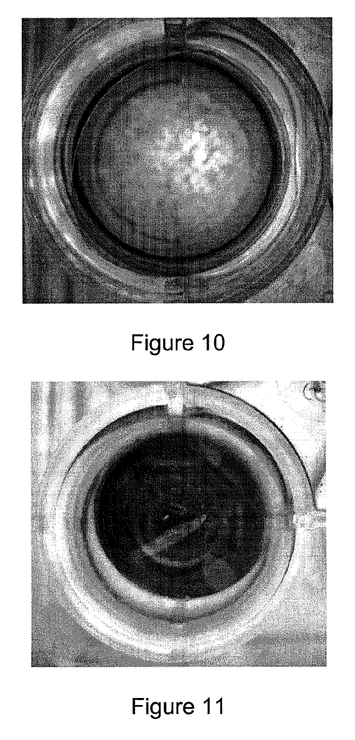

FIGS. 7 to 10 illustrate various hydrogel lenses that have been exposed to a gold nanoparticle solution. FIG. 7 shows a senofilcon A lens, FIG. 8 shows a comfilcon A lens, FIG. 9 shows a lotrafilcon B lens, and FIG. 10 shows a balafilcon A lens. Using different types, sizes or shapes of nanoparticles allows for a large range of possible tint colours as well as allowing for the optical density to be altered with a resultant tint.

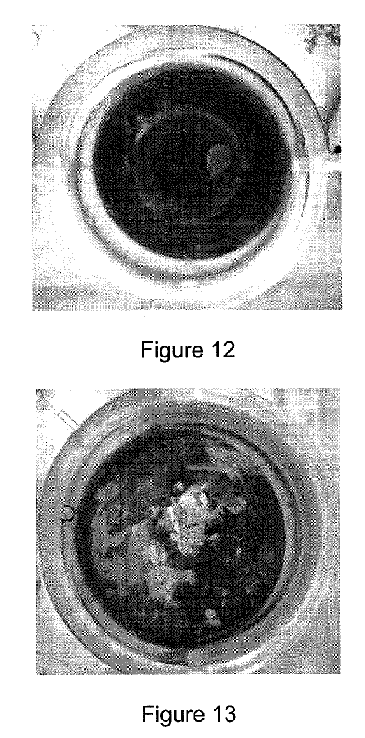

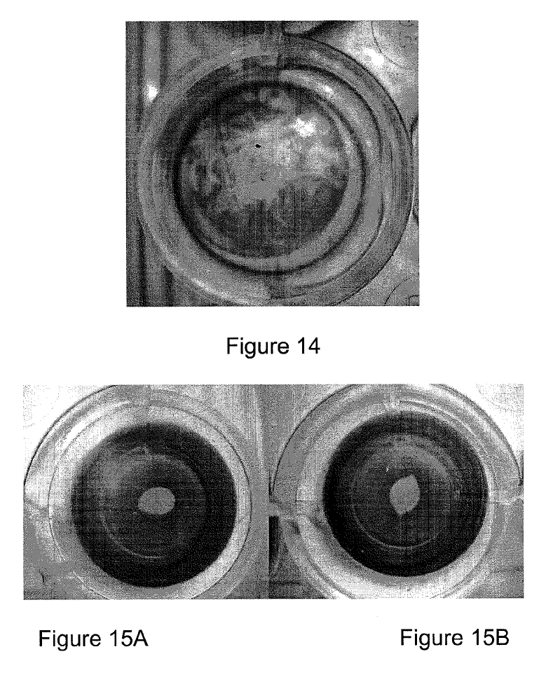

FIGS. 11 to 15 illustrate four types of hydrogel lenses when exposed to silver nanoparticle solutions. FIG. 11 is a senofilcon A lens, FIG. 12 shows a comfilcon A lens, FIG. 13 shows a lotrafilcon B lens, and FIG. 14 shows a balafilcon A lens. The lenses shown as particular examples, in FIGS. 7 to 15, were soaked for approximately 16 hours. The soaking time may be longer than required to achieve the saturated effect, and the lenses may be soaked for longer or shorter periods of time and still have the result of altered optical density or spectral response.

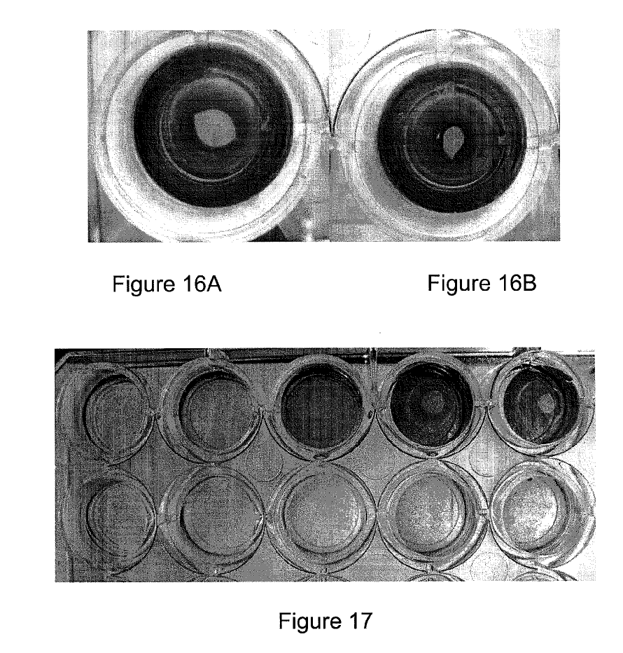

FIG. 15 illustrates two senofilcon A lenses that have been exposed to different ratios of the mixture of gold nanoparticles to silver nanoparticles. The lens on the left was exposed to a ratio of 1:1 and the lens on the right was exposed to a ratio of 3:1. FIG. 16 shows two senofilcon A lenses that were exposed to two other ratios of the mixture of gold nanoparticles to silver nanoparticles. The lens on the left was exposed to a ratio of 7:3 and the lens on the right was exposed to a ratio of 1:3.

FIG. 17 shows a progression of senofilcon A lenses exposed for various amounts of time. The top row was tinted using a solution with four times the concentration of the bottom row. From left to right, for both rows, the lenses were exposed for: no time, 30 minutes, 2 hours, 10 hours, and 24 hours. Either submerging the contact in a less concentrated solution or soaking it for less time may reduce the optical changes that occur, compared with exposing the lens for a longer time or in a more concentrated solution.

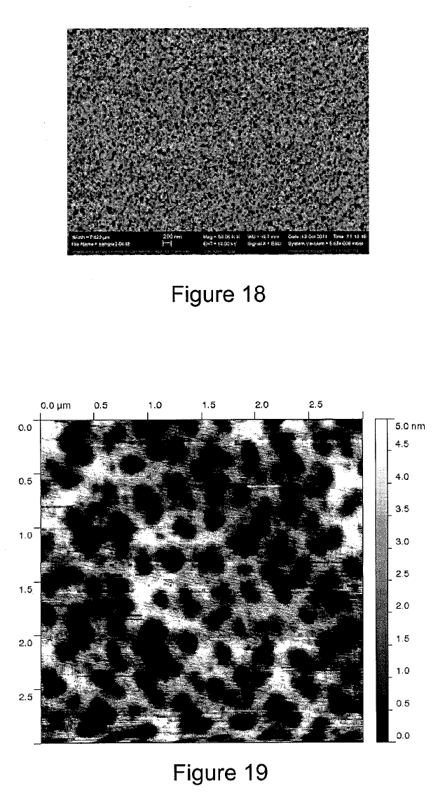

FIG. 18 is an electron microscopy image of a contact lens that has been soaked in a nanoparticle solution. As can be seen from the section the particles are disbursed throughout the surface of the contact lens, and the lens has clearly absorbed the nanoparticles, which result in optical changes such as a change in the perceived colour of the contact lens.

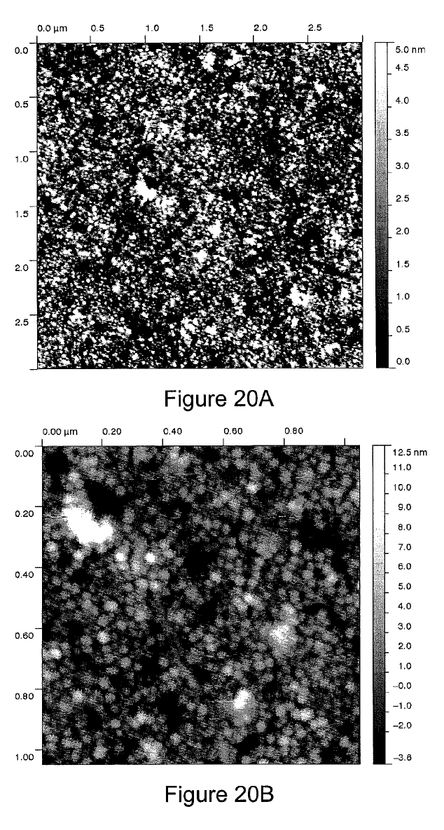

FIGS. 19 to 21 illustrate atomic force microscopy images of various contact lenses. FIG. 19 illustrates a lens not exposed to the treatment methods described above. FIGS. 20A and 20B illustrate atomic force microscopy images of a contact lens exposed to the treatment as described above. Both the colour and the black and white image illustrate the substantial quantity of nanoparticles coating the lens after being subjected to the treatment.

Some conclusions may be understood from the above figures. The nanoparticles within the nanoparticle solution became attached to the silicone hydrogel contact lens and to a lesser extent to the conventional hydrogel lens. The transmission percentage of the treated lenses is somewhat lower than 30% in the region near 550 nm. This has immediate application as a light attenuating treatment for both conventional and silicone hydrogel soft contact lenses.

The spectrum of the adsorbed nanoparticles is determined by the size, shape, and composition of the nanoparticles. While the data is shown for spherical gold nanoparticles, silver nanoparticles, and mixtures of the two, the peak of the absorption (and resulting colour of the lens) can be adjusted by using different sized spheres, by using nanorods instead of nanospheres or by using Au/Ag mixtures rather than pure metals in the nanoparticle synthesis. Optimization of this allows for the use of nanoparticle exposure to create tinted silicone hydrogel lenses of potentially any desired colour.

The contact lenses appear to have irreversibly adsorbed the nanoparticles, according to the data retrieved from the initial experimentation. Even after 4-6 months in buffer solution, there was no indication of any transfer of characteristic nanoparticle colour from the previously exposed lenses to the buffer solution.

One factor that required experimentation to ensure that the methods described above were appropriate to use with a product that comes into contact with a user's eye was the factor of wettability, the ability of a liquid to maintain contact with the surface of the contact lens. The purpose of this experiment was to test whether tinting Acuvue OASYS™ lenses with a gold nanoparticle solution would change the wettability of the contact lens, as assessed by the sessile drop advancing contact angle method.

A gold nanoparticle solution was created according to the methods described above. The optical density of this solution as prepared was 2.36 at 523 nm. This corresponds to a nanoparticle concentration of approximately 1.5×10̂(12)/mL and diameter of 20 nm.

In this experiment, seven Acuvue OASYS (senofilcon A) contact lenses were removed from their blister pack solutions, blotted on lens paper and were pre-soaked in a phosphate buffered saline (PBS) for 24 hours to remove any debris and packaging solution. Three lenses were then removed from the PBS, were rinsed in Milli-Q™ water (ultrapure water), blotted and were placed in the previously prepared gold nanoparticle solution. The lenses were left in the solution for approximately 20 hours at room temperature. Four lenses were pre-soaked and tested without nanoparticles.

The contact lenses were removed from either the nanoparticle or pre-soaking solution, and then rinsed in Milli-Q™ water and placed anterior side down on a piece of clean lens paper to remove any excess solution. Each lens was then taken from the lens paper and placed anterior side up on a convex mantle that mimicked the lens curvature. The mantle was then placed on an Optical Contact Analyzer directly underneath a syringe. A high speed camera was focused upon both the lens and the syringe and a 5 μl drop of a probe solution under investigation was dispensed from the syringe under computer control. The drop was allowed to stabilize and then the mantle was slowly and manually raised until contact was made with the contact lens. After the drop of solution had settled on the contact lens surface for two to three seconds, an image of the lens and water interface was taken. Due to the curved surface of the contact lens, a curved baseline profile-detection fitting algorithm was used to determine the angle that formed between the drop and the lens surface. The contact angle on the right and left of the image was determined and the mean recorded as the contact angle (CA) for that material.

All data are reported as mean±standard deviation and range, unless otherwise indicated. The data was investigated using an independent t-test, significance level was taken as p<0.05. The results of this experiment are shown in Table 1. As can be seen by the table, the advancing contact angle of the Acuvue OASYS lenses significantly decreased (p<0.001) after the lenses have been soaked in the gold nanoparticle solution for 20 hours.

TABLE 1
Advancing Contact Angle Results for
Tinted and Non-Tinted Acuvue OASYS

| | | Mean CA for | | |
|---|---|---|---|---|
| | Repeat | R/L (°) | Average CA(°) | STD |
| Pre-Soaked Only | 1 | 97.25 | 93.25 | 3.10 |
| | 2 | 96.35 | | |
| | 3 | 96.65 | | |
| | 4 | 102.9 | | |
| Soaked in Gold | 1 | 75.6 | 79.82 | 4.04 |
| Nanoparticle | 2 | 80.2 | | |
| Solution | 3 | 83.65 | | |

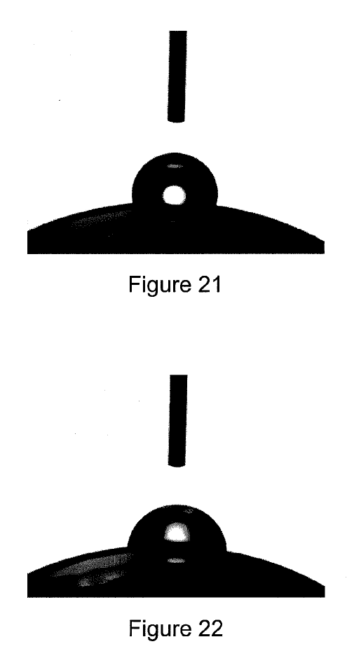

Photographs taken comparing the contact lens without being exposed and the gold nanoparticle exposed lens are seen in FIGS. 21 and 22.

In conclusion, there was a decrease in contact angle (or an increase in wettability) when the Acuvue OASYS lenses were exposed to the gold nanoparticle solution. Therefore, the wettability of Acuvue OASYS lenses is not negatively affected by exposure to gold nanoparticles.

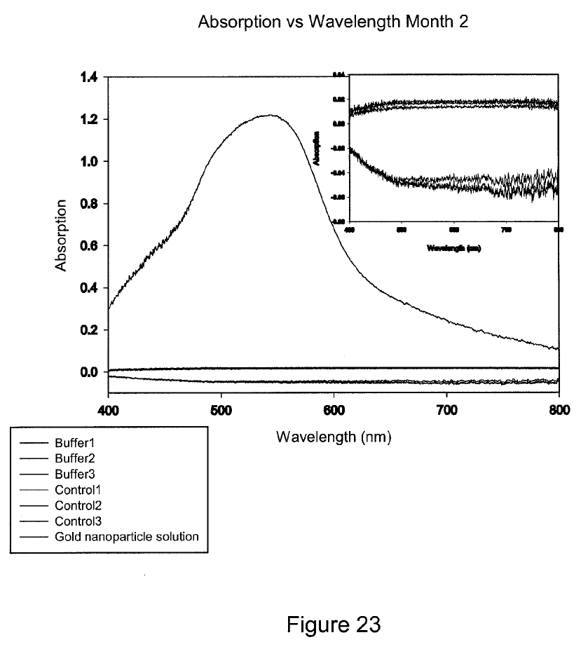

Not only did wettability need to be tested but leaching was another area that required testing to ensure the contact lenses would be appropriate for use in contact with a user's eye and for use over an extended period of time. FIG. 23 is a graph showing the absorption compared to the wavelength two months after the contact lens was exposed to a gold nanoparticle solution. From the graph, it can be seen that no leaching occurred during this period of time, indicating that a user would not be subject to leaching of the nanoparticles by using the contacts, whether in the short term or over a more extended period of time.

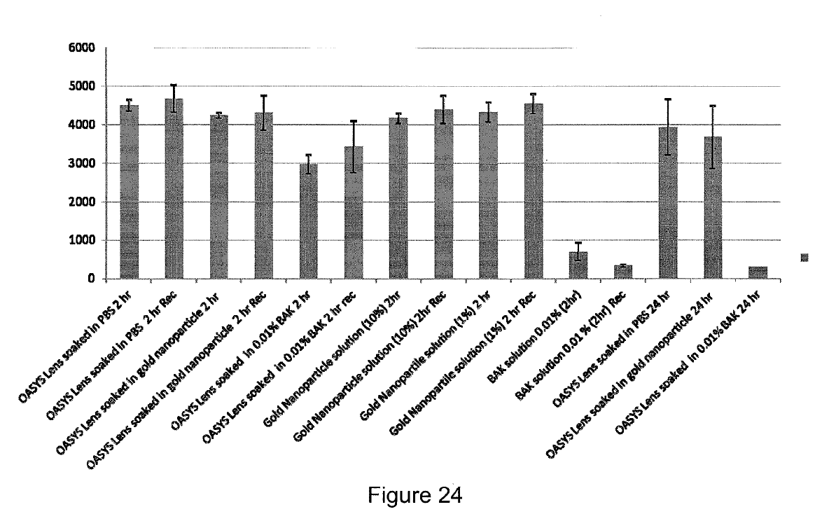

Another area requiring experimentation was the determination of possibility toxicity of the contact lens after being exposed to the nanoparticle solution as the lens would be making contact with the user's eyes. The gold nanoparticles treatment (with lens) at 2 hour exposure on Human Corneal Epithelial Cells (HCEC), and 24 hour exposure on HCEC were similar to the PBS control soaked lenses. After 2 hour exposure and 24 hour recovery there was not a decrease in the viability of the cells. Gold nanoparticles at (10%) or (1%) solution did not have a substantial effect on the viability of the HCEC. A graph illustrating the toxicity levels is shown in FIG. 24. The results indicate that exposing the contact lens to a nanoparticle solution does not negatively affect the contact lens and should therefore not negatively effect the user.

In the preceding description, for purposes of explanation, numerous details are set forth in order to provide a thorough understanding of the embodiments. However, it will be apparent to one skilled in the art that these specific details are not required.

The above-described embodiments are intended to be examples only. Alterations, modifications and variations can be effected to the particular embodiments by those of skill in the art without departing from the scope, which is defined solely by the claims appended hereto.

What is claimed is:

1. A method for altering the optical density and spectral transmission or reflection response of a contact lens comprising:
obtaining a nanoparticle solution having a predetermined concentration; and
exposing the contact lens in the nanoparticle solution for a predetermined period of time.

2. The method of claim 1 wherein the nanoparticles are gold, silver or a mixture of gold and silver nanoparticles.

3. The method of claim 1 wherein each nanoparticle is made of a combination of gold and silver.

4. The method of claim 1 wherein the contact lens is exposed to the nanoparticle solution for longer than 1 hour.

5. A contact lens comprising:
nanoparticles integrated with the contact lens.

6. The contact lens of claim 5 wherein the nanoparticles alter the optical density and spectral transmission or reflection response of the contact lens.

7. The contact lens of claim 5 wherein the nanoparticles are integrated on the surface of the contact lens.

8. The contact lens of claim 5 wherein the nanoparticles are directly incorporated within the contact lens.

9. The contact lens of claim 5 wherein the nanoparticles are metallic nanoparticles.

10. The contact lens of claim 9 wherein the nanoparticles are gold, silver, or a mixture of gold and silver nanoparticles.

11. The contact lens of claim 9 wherein each nanoparticle is made of a combination of gold and silver.

12. The contact lens of claim 5 wherein the lens is silicone hydrogel.

13. The contact lens of claim 5 wherein the nanoparticles integrated with the contact lens alter the optical properties of the contact lens.

14. A method for manufacturing a contact lens comprising:
exposing contact lens material to nanoparticles for a predetermined period of time to alter the optical density and spectral transmission or reflection response of the contact lens material.

15. The method of claim 14 further comprising forming the contact lens material at least one contact lens.

16. The method of claim 14 wherein the contact lens material has been formed into at least one contact lens prior to the exposure to nanoparticles.

17. The method of claim 14 wherein the nanoparticles are directly incorporated into the contact lens material.

18. The method of claim 14 wherein the nanoparticles are integrated onto a surface of the contact lens material.

19. The method of claim 14 wherein the nanoparticles are gold, silver or a mixture of gold and silver nanoparticles.

20. The method of claim 14 wherein each nanoparticle is made of a combination of gold and silver.
